(19) United States
(12) Patent Application Publication
(10) Pub. No.: US 2006/0008898 A1
(43) Pub. Date: Jan. 12, 2006

(54) Industrial composting system

(76) Inventor: Maurice Labbe, Stoke (CA)

Correspondence Address: KNOBBE MARTENS OLSON & BEAR LLP, 2040 MAIN STREET, FOURTEENTH FLOOR, IRVINE, CA, 92614, US

(21) Appl. No.: 11/178,218

(22) Filed: Jul. 8, 2005

(30) Foreign Application Priority Data
Jul. 9, 2004 (CA) 2,472,943

(51) Int. Cl. C05F 17/02

(52) U.S. Cl. 435/290.4

(57) ABSTRACT

An industrial composting system is provided. Organic matter to be composted is received in a first hopper at a receiving station and structuring elements are poured in a second hopper. The contents of both hoppers are discharged together on a transfer conveyor in a controlled manner. The resulting composting mix is brought to a piling conveyor at the center of a ring-shaped configuration of composting cells. The piling conveyor is telescopic and provides for the even piling of the composting mix on the composting cells.

### FIELD OF THE INVENTION

The present invention relates to the field of composting and more particularly concerns an industrial composting system for the automated large scale transformation of organic matter into compost.

### BACKGROUND OF THE INVENTION

The production of large quantities of compost from organic matter is a time consuming process which requires the use of a lot of space. In general, the organic matter to be composted is unloaded in a large field where it is left for a period of time sufficient for the transformation to take place naturally.

This process is greatly inefficient. One way to accelerate it is to stir the pile regularly. This technique however has the drawback of releasing foul odours which is bothersome to anyone in the vicinity of the composting field, these odours being carried away on great distances depending on meteorological conditions.

It is known in the art to use more complex systems for the large scale production of compost. The distribution of composting cells in a circular arrangement is for example shown in U.S. Pat. No. 5,661,030 (ROLONSKI) and German patent application no. DE 43 42 704 A1 (UNHOLZ). In both cases, the cells form a complete circle and a complex conveying system is necessary for piling the organic matter on the cells and removing the mature compost. UK patent application no. GB 2 042 492 (FRISK et al.) shows another circular system where a section of the ring is temporarily left empty; the composting matter is periodically moved from cell to cell around the circle and the empty cell allows this movement. It suffers however from the same drawbacks as the other circular composting systems described above.

In view of the above, there is therefore a need for a simple centralized, automated composting system which alleviates some of the drawbacks of the prior art.

### SUMMARY OF THE INVENTION

Accordingly, the present invention provides an industrial composting system for compositing organic matter. This system first includes a receiving station including a first hopper for receiving and dispensing the organic matter, and a second hopper for receiving and dispensing structuring elements. Each of the hoppers is provided with a flow control mechanism. A mechanical transfer assembly for jointly receiving and transferring the organic matter and structuring elements dispensed from the hoppers is also provided.

The system further includes a plurality of composting cells disposed in a ring-shaped configuration having a broken section; the mechanical transfer assembly extends therethrough. Finally, there is provided a piling conveyor having an input end receiving the organic matter and structuring elements from the transfer assembly, this input end being positioned at a generally central point of the ring-shaped configuration. The piling conveyor is rotatable around the central point and has a telescopic output end for unloading the organic matter and structuring elements on the composting cells.

The system of the present invention is advantageously both simple and efficient. The broken ring-shaped configuration allows easy access to the composting cells and the telescopic piling conveyor provides for the even piling of the organic material to be composted.

Other features and advantages of the present invention will be better understood upon reading of preferred embodiments thereof with reference to the appended drawings.

### BRIEF DESCRIPTION OF THE DRAWINGS

FIG. 1 is a top view of a composting system according to a preferred embodiment of the invention.

FIG. 2 is a cross-sectional side view of the composting system of FIG. 1.

FIG. 3A is a front view of a receiving station for the system of FIG. 1; FIG. 3B is a rear view of the receiving station of FIG. 3A; and FIG. 3C is a cross-section taken along lines III-III of FIG. 3B.

FIG. 4 is a cross-sectional side view of a composting cell and bio-filter of a composting system according to a preferred embodiment of the invention

### DETAILED DESCRIPTION OF THE PREFERRED EMBODIMENT

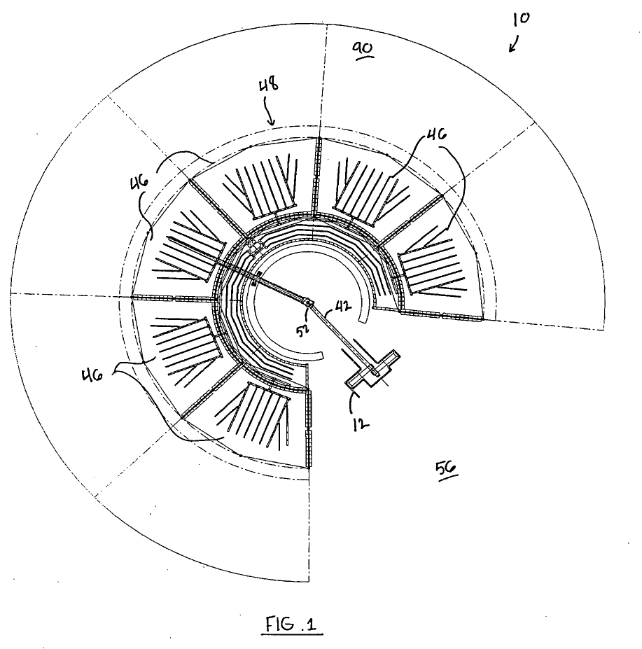

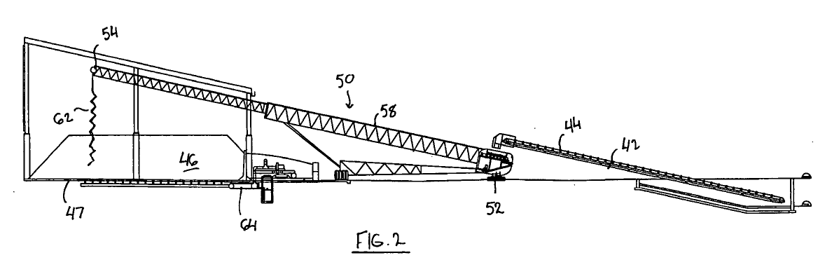

With reference to FIG. 1, there is shown a composting system 10 according to a preferred embodiment of the invention. The system 10 of the present invention allows for the composting of organic matter at an industrial scale. The starting matter may be received, mixed with structuring elements according to pre-determined proportions, and piled on composting cells in an automated manner.

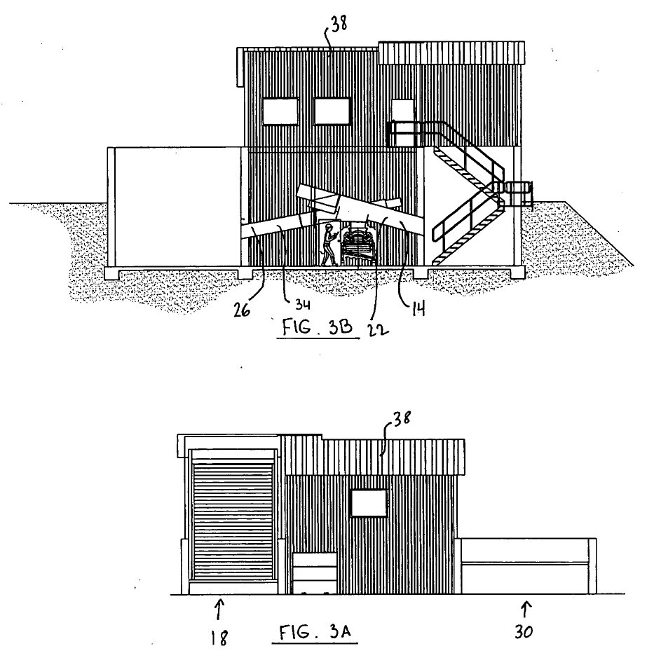

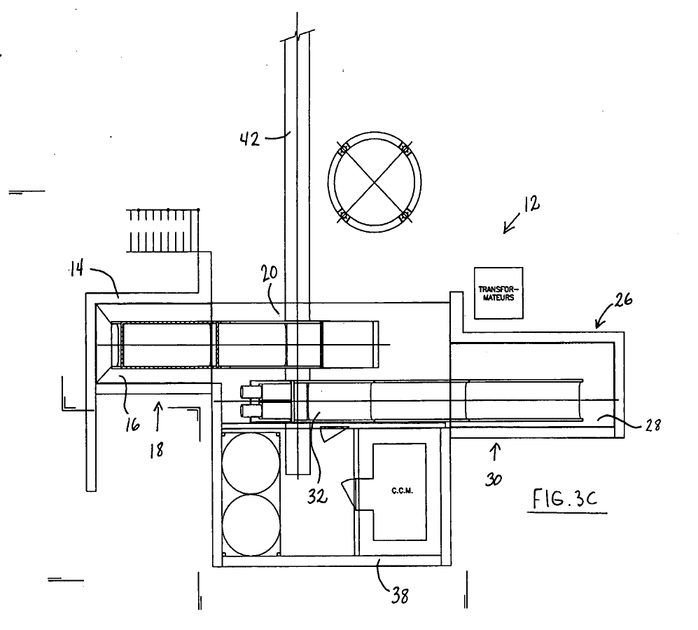

Referring to FIGS. 1, 3A, 3B and 3C, in the preferred embodiment of the invention, the composting system 10 first includes a receiving station 12, which has two main functions: receiving the organic matter to be composted and mixing it with structuring elements. The receiving station therefore includes a first hopper 14 for receiving and dispensing the organic matter. Preferably, the first hopper includes a funnel-shaped receptacle 16 receiving the organic matter at its input top end 18 and discharging it from its output bottom end 20. To control the volume of organic matter discharged, the bottom end 20 is provided with a flow control mechanism. In the preferred embodiment, the flow control mechanism is a worm screw 22 extending across the bottom end 20 of the receptacle 16, and operated by a speed controller for controlling its rotation speed. It will be apparent that the greater the rotation speed of the worm screw, the greater the discharging flow.

The receiving station 12 also hosts a second hopper 26 for receiving and dispensing structuring elements. By “structuring elements”, it is meant any additives commonly added to composting matter for giving it structure so that air will flow through, which can also act as a source of carbon for equilibrating the carbon-nitrogen ratio in the composting matter and to promote drying of the composting matter through absorption of liquids. All of these functions may be accomplished by the use of wood chips as structuring elements, but other additives may also be considered, such as recycled shredded tires.

The second hopper 26 is preferably of a similar construction as the first hopper 14 and therefore includes a receptacle 28 having an input top end 30 and an output bottom end 32 provided with a flow control mechanism such as a worm screw 34 operated by a speed controller. It is understood that both hoppers 14 and 26 may be independently or jointly controlled.

In the preferred embodiment, the first and second hopper 14 and 26 are housed in a ventilated building 38 for controlling the odours released by the waste organic matter when handled.

Referring to FIGS. 1, 2 and 3C, the system 10 further includes a mechanical transfer assembly for jointly receiving and transferring the organic matter and structuring elements dispensed from the hoppers 14 and 26. The mechanical transfer assembly may include any number of components necessary for its purpose, and preferably includes at least one transfer conveyor 42. Preferably, the organic matter and structuring elements each fall directly on the transfer conveyor 42 to be carried away from the receiving station. In order to control odours during this operation, the transfer conveyor may advantageously be provided with a top cover 44 over at least a portion of its length.

Referring to FIGS. 1 and 2, the mixed organic matter and structuring elements need to be piled on composting cells to be transformed into compost. According to the present invention, a plurality of such composting cells 46 are provided, disposed in a ring-shaped configuration 48 (see FIG. 1). In order to pile the mixed organic matter and structuring elements on the composting cells 46, a piling conveyor 50 is provided. The piling conveyor 50 has an input end 51 positioned at a generally central point 52 of the ring-shaped configuration 48. In the preferred embodiment, the mixed organic matter and structuring elements are unloaded from the transfer conveyor 42 to fall on the input end 51 of the piling conveyor 50, which conveys the mix upward to its output end 54, from which it is unloaded on the composting cells 46.

The piling conveyor 50 is rotatable around the central point 52 of the ring 48 and its output end 54 is telescopic; it may therefore be moved radially, tangentially and vertically in order to unload the organic matter and structuring elements on the composting cells in successive layers. For example, in the preferred embodiment, the piling conveyor 50 piles the composting matter from the outside toward the inside in layers of 1 to 6 feet, and starts over until the height of the pile reaches its target value, preferably between 10 and 15 feet. Similarly to the transfer conveyor, the piling conveyor may be provided with a top cover 58 over at least a portion of its length.

It will be noticed that the ring-shaped configuration 48 has a broken section 56, through which the transfer conveyor 42 extends to reach the piling conveyor 50. This broken section provides easy access to the composting cells and related components of the composting system 10. In the preferred embodiment, the broken section spans approximately 90° of the ring-shaped configuration. The composting cells 46 are preferably radial and each form a ring section. In the illustrated example, it can be seen that six such cells are provided, but of course any other appropriate number would be considered within the scope of the present invention. Each cell 46 preferably includes a water-proof platform 47 and a ventilation system 64, the operation of which will be described further below.

In an other preferred embodiment, the piling conveyor 50 may be provided with a mixing screw 62 projecting downwardly from its output end 54. The mixing screw may advantageously be used to mix the piled composting matter in order to accelerate the composting process. In the preferred embodiment, it is a removable tool which is long enough to reach through the compost pile but has a small diameter. It may be provided with lateral wings allowing it to more easily move the piled compost.

Advantageously, the system 10 may be provided with an automated control system for automatically controlling the components described above, more particularly the worm screws of the hoppers, and all conveyors. If present, the mixing screw may also be controlled by the automated control system. In the preferred embodiment, a control room is provided in the building 38 of the receiving station allowing an operator to supervise the system's operations. Any one of a variety of appropriate systems apt to perform such a control of mechanical components may be used and the present invention is not limited to any particular manner of doing so.

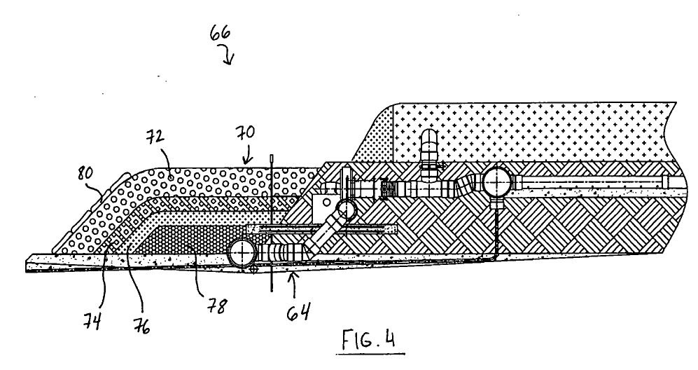

Referring to FIG. 4, in the preferred embodiment of the present invention, the composting system includes a ventilation system 64 of any type known in the art. Preferably, the ventilation system includes fans, air conduits and valves for directing air. More preferably, the ventilation system can be used in negative mode. By “negative”, it is meant that the air is sucked down through the compost towards the bottom. This technique advantageously helps to control odours.

Still referring to FIG. 4, the composting system may further include a bio-filter 66 which is preferably disposed along the ring-shaped configuration inwardly of the composting cells. It preferably includes fans, air conduits, a bacteria-containing medium, a conduit for recuperating waste water and a conduit for spraying leacheate. The bio-filter has a double function, that of treating water and treating air. In the preferred embodiment, the active medium 70 of the bio-filter 66 includes the following layers, from top to bottom: softwood bark 72, mature compost 74, ground cedar wood chips 76 and stones 78 of about 1″. The layered medium may also be provided with a riprap 80 of stones on its sloped inner edge.

In accordance with another aspect of the invention, there is provided a composting process for use with a composting system as described above. It is understood however that this particular process is given by way of example and that the invention is in no way limited thereto.

The method may include an optional preliminary step of dehydrating the liquid organic matter according to any well known technique. As seen above, the organic matter to be composted is then received on site and poured into the first hopper. Structuring elements such as wood chips are poured in the second hopper and both are controllably dispensed on a transfer conveyor, where the mix of the two forms the composting matter. This composting matter is conveyed along and piled on a given composting cell. At this point, the composting process begins. The composting matter is first preferably dehydrated by the ventilation pipe system working in negative mode. The composting matter may be mixed using the mixing screw described above. The composting matter is also ventilated using a negative forced ventilation system. The quantity of air sucked down is preferably controlled according to the desired oxygen saturation and temperature. The ventilation time is from 20 to 40 days in negative mode. A positive (upward through the pile) ventilation period of 0 to 20 days may then be provided. At the end of this period, the thermophile phase of the compost is completed. Throughout this phase, odours are controlled by directing the contaminated air in the ventilation pipe system towards a bio-filter 66, where it is treated before being rejected outside.

Soiled water is sucked down by fans. It circulates in the ventilation pipes but is redirected towards a tank before it can reach the fans. It is then pumped by pipes directing it above the bio-filter and is sprayed thereon. It is therefore biologically treated as it goes through the bio-filter, which retains solid particles therefrom. At the bottom of the bio-filter, the treated water is taken by pipes which direct it to either an additional treatment facility or into nature, if appropriate parameters are met.

At the end of the composting, the cells are emptied and the brut compost is sieved to separate the fine compost, which is piled elsewhere for a maturation period, from the structuring elements. The structuring elements may then be re-used in the system of the present invention for another cycle. In the preferred embodiment illustrated in FIG. 1, a maturation area 90 is provided surrounding the composting cells 46 for receiving the fine compost.

Of course, numerous modifications could be made to the embodiments described above without departing from the scope of the invention as defined in the appended claims.

What is claimed is:

1. An industrial composting system for compositing organic matter, said system comprising:
a receiving station including a first hopper for receiving and dispensing said organic matter and a second hopper for receiving and dispensing structuring elements, each of said hoppers being provided with a flow control mechanism;
a mechanical transfer assembly for jointly receiving and transferring said organic matter and structuring elements dispensed from said hoppers;
a plurality of composting cells disposed in a ring-shaped configuration having a broken section, the mechanical transfer assembly extends therethrough; and
a piling conveyor having an input end receiving said organic matter and structuring elements from the transfer assembly, said input end being positioned at a generally central point of said ring-shaped configuration, said piling conveyor being rotatable around said central point and having a telescopic output end for unloading the organic matter and structuring elements on said composting cells.

2. The industrial composting system according to claim 1, wherein each of said hoppers comprises a receptacle having an input top end and an output bottom end, said bottom end being provided with said flow control mechanism.

3. The industrial composting system according to claim 2, wherein said receptacle is funnel-shaped.

4. The industrial composting system according to claim 2, wherein the flow control mechanism of each of said hoppers comprises a worm screw extending across the bottom end of the corresponding hopper, said control mechanism further comprising a speed controller for controlling a rotational speed of said screw.

5. The industrial composting system according to claim 1, wherein said receiving station comprises a ventilated building enclosing said first and second hoppers.

6. The industrial composting system according to claim 1, wherein said structuring elements comprise wood chips.

7. The industrial composting system according to claim 1, wherein said mechanical transfer assembly comprises at least one transfer conveyor extending between the receiving station and the piling conveyor.

8. The industrial composting system according to claim 7, wherein at least a portion of said transfer conveyor is provided with a top cover.

9. The industrial composting system according to claim 1, wherein at least a portion of the piling conveyor is provided with a top cover.

10. The industrial composting system according to claim 1, further comprising an automated control system controlling said flow control mechanism, said mechanical transfer assembly and said piling conveyor.

11. The industrial composting system according to claim 1, further comprising a mixing screw projecting downwardly from the output end of the piling conveyor for mixing said organic matter and structuring elements unloaded on the compositing cells.

12. The industrial composting system according to claim 1, wherein the broken section of the ring-shaped configuration spans about 90°.

13. The industrial composting system according to claim 1, wherein each of said composting cells comprises a water-proof platform and a ventilation system.

14. The industrial composting system according to claim 13, wherein said ventilation system operates in a negative mode.

15. The industrial composting system according to claim 1, further comprising a bio-filter disposed along said ring-shaped configuration inwardly of the composting cells.
